(19) United States
(12) Patent Application Publication
(10) Pub. No.: US 2018/0005775 A1
(43) Pub. Date: Jan. 4, 2018

(54) OPERATING MECHANISM FOR TRIPPING A VOLTAGE CIRCUIT BREAKER

(71) Applicant: General Electric Technology GmbH, Baden (CH)

(72) Inventor: Peter VON ALLMEN, Oberentfelden (CH)

(21) Appl. No.: 15/547,128

(22) PCT Filed: Jan. 28, 2016
(86) PCT No.: PCT/EP2016/051763

§ 371 Date: Jul. 28, 2017

(30) Foreign Application Priority Data
Jan. 30, 2015 (EP) 15153300.7

(51) Int. Cl. H01H 9/54; H01H 71/44; H01H 71/24

(52) U.S. Cl. CPC H01H 9/54; H01H 71/24; H01H 71/44

(57) ABSTRACT

An operating mechanism for tripping a circuit-breaker, the operating mechanism comprising a coil having a first terminal and a second terminal, means for generating a first electric impulse, and means for creating, from the first electric impulse, a second electric impulse delayed from the first electric impulse and applied between the first terminal and the second terminal of the coil, characterized in that the means for creating the second electric impulse comprise a delaying circuit and a switch connected in series with the coil, the delaying circuit having an input connected to an output of the means for generating a first electric impulse and an output which delivers the second electric impulse, said second electric impulse being a command signal of the switch.

### TECHNICAL FIELD

The present invention relates to an operating mechanism for tripping a voltage circuit-breaker and, more particularly, to an operating mechanism for tripping a high and medium voltage circuit-breaker.

### BACKGROUND OF THE INVENTION

The energy to trip a voltage circuit-breaker is stored either in a spring (spring-operated mechanism) or in a hydraulic tank (hydraulic-operated mechanism). The spring is held in its charged position using a latching-system, while the hydraulic tank is kept under pressure by a closed valve. To trip the circuit-breaker, the latching-system or the valve is opened either manually or by a magnetic force created by a current flowing through a coil, the current resulting from an electric impulse applied to the coil.

For some applications, the tripping time of the circuit-breaker has to be prolonged by several milliseconds to meet the requirements of the circuit-breaker.

According to the prior art, an additional mass is attached to the latching-system of the mechanism. Due to the inertia of the additional mass, the tripping-time is delayed.

The FIG. 1 shows a latching-system according to the prior art. The additional mass is here a pendulum mass. The latching-system comprises a magnetic solenoid to pick up the coil 1, a pendulum mass 2 and a damper for pendulum 3.

Such a mechanism has several drawbacks, i.e.: the system is position-dependent (the pendulum must be in vertical position to operate correctly, which presupposes that the mechanism must be fixed to the circuit-breaker in this unique position); the pendulum needs a lot of space, enlarging therefore the size of the mechanism; the latching-system comprises several mechanical parts, increasing thereby the cost of the mounting and the adjusting of the system; the different mechanical parts which constitute the latching-system are exposed to high accelerations and vibrations so that these parts can get loose and defective; the time-delay of the mechanical system is depending not only on its mass but also on the force acting to its latch so that adjusting the energy of the mechanism leads to another force on the latch and thus to a change in time-delay; the mass of the pendulum rises quadratically to the delay time so that using acceptable mass leads to a delay time limited to about 50 milliseconds.

### SUMMARY OF THE INVENTION

Embodiments of the present invention relates to an operating mechanism for tripping a circuit-breaker, the operating mechanism comprising a coil having a first terminal and a second terminal, means for generating a first electric impulse, and means for creating, from the first electric impulse, a second electric impulse delayed from the first electric impulse and applied between the first terminal and the second terminal of the coil, characterized in that the means for creating the second electric impulse comprise a delaying circuit and a switch connected in series with the coil, the delaying circuit having an input connected to an output of the means for generating a first electric impulse and an output which delivers the second electric impulse, said second electric impulse being a command signal of the switch.

According to another feature of the invention, the delaying circuit comprises a timer circuit having an input and an output, an integrating circuit and a driving circuit, the integrating circuit being connected at the input of the timer circuit and the first electric impulse being applied at the terminals of integrated circuit, and the driving circuit being connected at the output of the timer circuit and delivering the command signal of the switch as soon as a voltage at the input of the timer circuit reaches a trigger-level.

The operating mechanism of an embodiment of the invention comprises an electronic component able to delay the electric impulse applied to the coil by the time required.

According to an embodiment of the invention, the electronic component able to delay the electric impulse is integrated with the coil in a same component.

The operating mechanism of embodiments of the invention has several advantages, i.e.: it is independent of the position of the drive, adjusting the energy of the mechanism does not influence the delay-time, the operating-mechanism has less mechanical parts than the operating-mechanism of the prior art, which is much more reliable and cost saving, the repeatability of a same delay-time is much more better than the one of the prior art, according to an embodiment of the invention, there is no supplementary space needed in the mechanism because the means to delay the impulse is integrated with a coil in a same component.

### BRIEF DESCRIPTION OF THE DRAWINGS

Other characteristics and advantages of the present invention will become clearer upon reading embodiments of the invention made in reference to the attached figures, wherein:

FIG. 1—already described—depicts an operating mechanism for tripping a voltage circuit-breaker according to the prior art;

FIG. 2 depicts a diagram of an operating mechanism for tripping a voltage circuit breaker;

FIG. 3 depicts an example of the operating mechanism;

FIG. 4 depicts an improvement of the example of operating mechanism represented in FIG. 3.

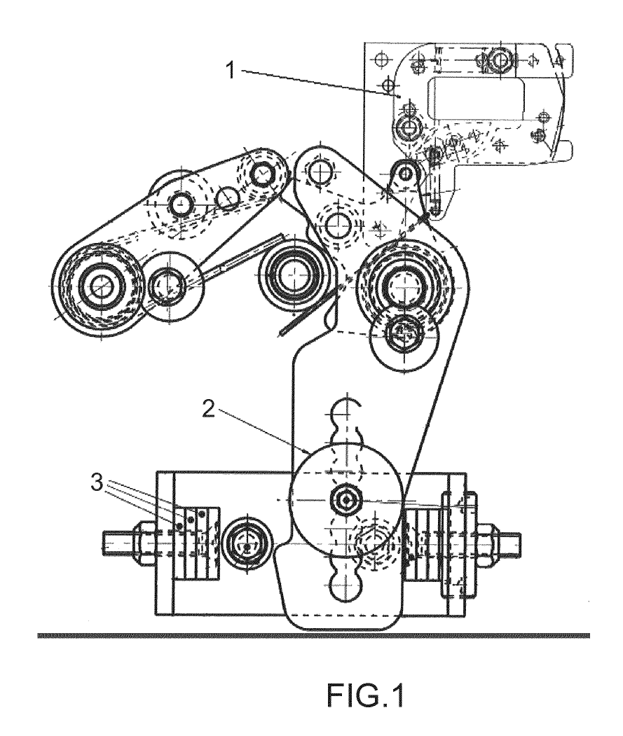

In all the figures, an effort has been made to use the same reference numerals to designate the same elements, whenever possible.

### DETAILED DESCRIPTION OF THE INVENTION

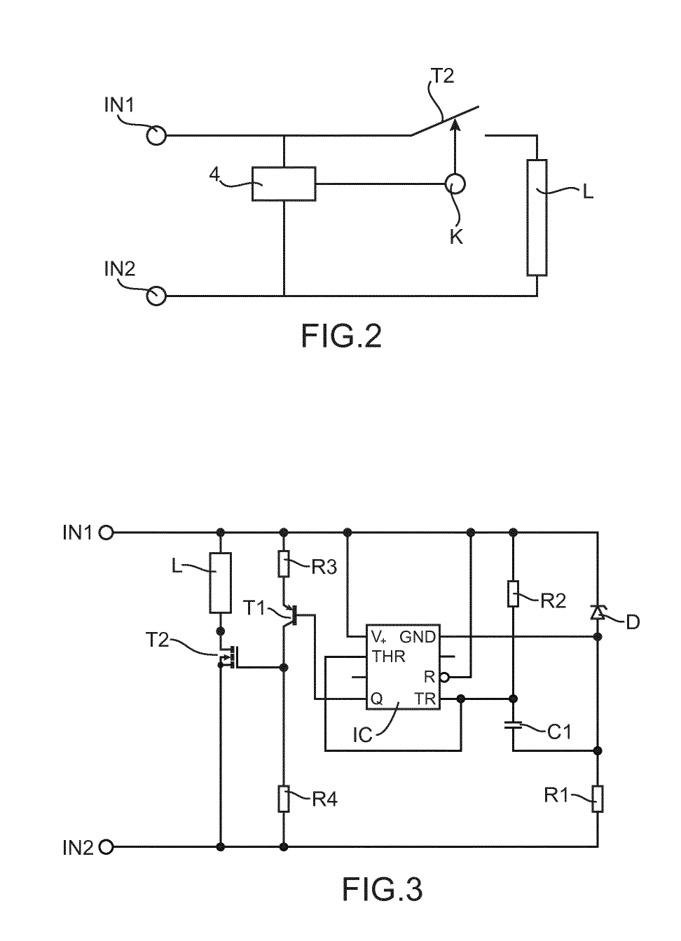

The FIG. 2 represents a diagram of an operating mechanism for tripping a voltage circuit breaker.

The operating mechanism comprises means for generating an electric impulse (not shown on the figure), means for delaying the electric impulse 4, T2 and a coil L. The means for delaying the electric impulse are a delaying circuit 4 and a switch T2.

The delaying circuit 4 has a first input terminal IN1 connected to a first output of the means for generating the electric impulse, a second input terminal IN2 connected to a second output of the means for generating the electric impulse and an output terminal K connected to the input command of the switch T2.

The coil L is in series with the switch T2. The switch T2 is OFF (open circuit) before the electric impulse is applied between the first terminal IN1 and the second terminal IN2.

When the electric impulse is applied between the terminals IN1 and IN2, the delaying circuit 4 is powered on. When powered on, the delaying circuit 4 comprises means able to output, on the output terminal K, a pulse signal after a duration equal to the time-delay required. This pulse signal switches ON the switch T2 (short circuit) so that a magnetic force is created.

The FIG. 3 represents an example of the operating mechanism.

The operating mechanism comprises the resistors R1, R2, R3, R4, a timer circuit IC, a condenser C1, a diode D, a bipolar transistor T1 and the switch T2. The switch T2 is for example a field effect transistor.

The coil L is in series with the transistor T2. The transistor T1 is in series with the resistors R3 and R4, a first terminal of the resistor R3 being connected to the emitter of the transistor T1 and a first terminal of the resistor R4 being connected to the collector of the transistor T1. The collector of the transistor T1 is connected to the gate of the transistor T2, which gate is the input command of the switch. The second terminal of the resistance R3 is connected to a first terminal of the coil L, the second terminal of which is connected to a first terminal of the switch T2, the second terminal of which is connected to the second terminal of the resistor R4. A first terminal of the resistor R2 is connected to a first terminal of the condenser C1, the second terminal of which is connected to a first terminal of the resistor R1. The second terminal of the resistor R2 is connected to the second terminal of the resistor R3 and the second terminal of the condenser C1 is connected to the second terminal of the resistor R4. The first terminal of the resistor R1 is also connected to a first terminal of the diode D1, the second terminal of which is connected to the second terminal of the resistor R2. The diode D and the resistor R1 are connected to the timer circuit IC so as to stabilize the supply-voltage of the timer circuit.

The main elements allowing to delay the electric impulse are the timer circuit IC, the condenser C1 and the resistor R2. The first terminal of the condenser C1 is connected to an input TR of the timer-circuit IC. The gate of the transistor T1 is connected to an output Q of the timer circuit IC.

When the electrical impulse is applied between the terminals IN1 and IN2, the timer circuit IC is powered on and, as long as the voltage at the input TR of the timer circuit is lower than a trigger-level, the output Q of the timer circuit IC stays at a logical level “high”, keeping the transistor T1 closed. As soon as the trigger-level is reached at the input TR, the output Q turns to a logical level “low”, opening thereby the transistor T1. Thus, the gate of the transistor T2 gets charged and the transistor T2 conducts. The coil L is therefore supplied. The transistor T1, together with the resistors R3 and R4 are to drive the transistor T2 from the logical signal output by the timer cicuit IC.

It is therefore possible to set the time delay when an electric impulse is applied between the terminals of the coil.

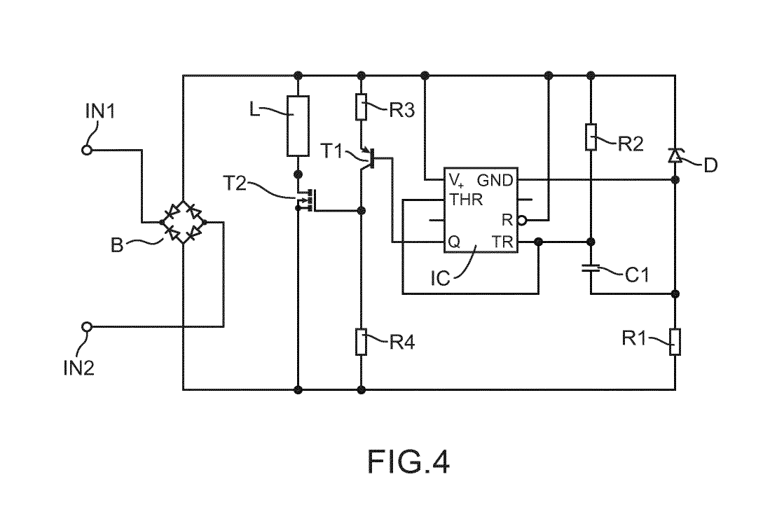

The FIG. 4 represents an improvement of the example of means represented in FIG. 3.

In addition to the elements represented in FIG. 3, the operating mechanism represented in FIG. 4 comprises a rectifier B placed between the terminals IN1 and IN2. This rectifier makes the circuit independent of polarity and suitable for active current AC and direct current DC.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An operating mechanism for tripping a circuit-breaker, the operating mechanism comprising
a coil having a first terminal and a second terminal,
means for generating a first electric impulse, and means for creating, from the first electric impulse,
a second electric impulse delayed from the first electric impulse and applied between the first terminal and the second terminal of the coil,
wherein the means for creating the second electric impulse comprise a delaying circuit and a switch connected in series with the coil, the delaying circuit having an input connected to an output of the means for generating a first electric impulse and an output which delivers the second electric impulse, said second electric impulse being a command signal of the switch.

2. The operating mechanism according to claim 1, wherein the delaying circuit comprises a timer circuit having an input and an output, an integrating circuit and a driving circuit, the integrating circuit being connected at the input of the timer circuit, the first electric impulse being applied at the terminals of integrated circuit, and the driving circuit being connected at the output of the timer circuit and delivering the command signal of the switch as soon as a voltage at the input of the timer circuit reaches a trigger-level.

3. The operating mechanism according to claim 2, wherein the integrating circuit comprises a condenser at the terminals of which the first electric impulse is applied and the driving circuit comprises a PNP transistor the gate of which is connected to the output of the timer circuit and the collector of which is connected to an input command of the switch.
